(19) United States
(12) Patent Application Publication
(10) Pub. No.: US 2009/0094266 A1
(43) Pub. Date: Apr. 9, 2009

(54) METHOD FOR DATA COMPRESSION AND QUALITY CHECKING

(75) Inventor: Joseph C. SLONE, Batavia, IL (US)

Correspondence Address: PILLSBURY WINTHROP SHAW PITTMAN, LLP, P.O. BOX 10500, MCLEAN, VA, 22102, US

(73) Assignee: eCPG.net, INC., Chicago, IL (US)

(21) Appl. No.: 12/332,694

(22) Filed: Dec. 11, 2008

Related U.S. Application Data
(63) Continuation of application No. 11/183,845, filed on Jul. 19, 2005, now abandoned.
(60) Provisional application No. 60/634,600, filed on Dec. 10, 2004.

(51) Int. Cl. G06F 17/00

(52) U.S. Cl. 707/101; 707/E17.005

(57) ABSTRACT

Pricing data from a manufacturer is condensed to remove duplicate data and filtered to detect discrepant data. The non-discrepant data is delivered to a retailer and the discrepant data is delivered to the manufacturer for correction. The condensing is done by hashing the data using a key consisting of the data's price information and a value consisting of the retailer store associated with the data. The filtering is done by using the condensed data and hashing with a key consisting of the stores and a value consisting of the pricing information.

### PRIORITY INFORMATION

This is a continuation of U.S. patent application Ser. No. 11/183,845, filed Jul. 19, 2005, which, in turn, claims the benefit of priority to U.S. Provisional Application No. 60/634,600, filed Dec. 10, 2004, the entire contents of both of which are incorporated herein by reference in their entireties.

### BACKGROUND OF THE INVENTION

1. Field of the Invention

The present invention relates generally to computer systems and more particularly to a software implemented method for condensing and/or filtering data. The method of condensing and/or filtering data is capable of being used in the manufacturer/retailer supply chain.

2. Description of Related Art

In the past, manufacturers have sent detailed pricing data to retailers for each product that was carried in each retailer store. For manufacturers with thousands of products and retailers with thousands of stores, this was a large amount of data since the product prices would vary over time and each price could consist of detailed information such as start and end date, type of price (wholesale, retail, special discount) and the value. This data could come from multiple manufacturer sources and could contain discrepant data, that is data for the same product that was different in some stores when it should have been the same in a given set of stores. Detecting errors or inconsistencies in the data and correcting this data was inefficient because of the volume of data and lack of centralized processing.

### BRIEF SUMMARY OF THE INVENTION

In accordance with at least one embodiment of the present invention provides a method to condense and/or filter data using hashing. Starting with a set of manufacturer's pricing data for a given item sold in multiple stores (where the pricing data should be consistent across the set of retailer stores), the pricing information may first be condensed by hashing the price data using a key of (start date, end date, type, price) and a value of the store ID for the item. This results in a hashtable containing a single entry for like keys (condensed price information) and a list of stores for that key (where the price information is used).

Subsequently, and optionally, it is possible to detect discrepancies. This may be done by further hashing the resulting condensed data by taking the data for each entry (e.g., key, value) in the previous hashtable, creating a new key using the list of stores contained in the value, creating a new value using the price information contained in the key (e.g. start date, end date, type, price), and entering this into a new hashtable. This results in a hashtable containing a set of pricing information for a set of stores. If a discrepancy exists, then there may be more than one key in this hashtable. Subsequently, the discrepancies can be returned to the manufacturer for resolution.

### BRIEF DESCRIPTION OF THE DRAWINGS

Various exemplary embodiments of this invention will be described in detail, with reference to the following figures, wherein:

FIG. 1 is a flow diagram illustrating the method and apparatus according to at least one embodiment of the present invention;

FIG. 2 is a flow diagram illustrating operations involved in the condensing operation for the condensing of the items common price adjustments;

FIG. 3 is a flow diagram illustrating operations involved in the filtering operation for the filtering of the store lists to detect discrepancies;

FIG. 4 is a flow diagram illustrating operations involved in detecting a discrepancy;

FIG. 5 is a diagram illustrating exemplary contents of the Pricing Records, Condensed Hashtable and Filtered Hashtable used in connection with the condensing and/or filtering operations illustrated in FIGS. 2 and 3;

FIG. 6 is a flow diagram illustrating operations involved in the condensing operation for the condensing of the items common price adjustments according to at least one embodiment of the present invention;

FIG. 7 is a flow diagram illustrating operations involved in the filtering of the store lists and detection of discrepancies according to another embodiment of the present invention; and

FIG. 8 is a diagram illustrating the structure of the priceObjectList, priceObject and storeList used in connection with the condensing and filtering operations disclosed in FIGS. 6 and 7.

FIGS. 9-12 are diagrams illustrating the various combinations of communications between manufacturers and retailers.

### DETAILED DESCRIPTION OF THE INVENTION

As manufacturers have started to use centralized processing facilities (e.g., data pools) to collect their data and deliver it to retailers, it has become possible to operate on the data in a manner that overcomes the previously inherent problems of volume and discrepant data. There is a need to provide a software implementable method for compressing and quality checking pricing data on a product specific, manufacturer specific and/or retailer specific basis. Accordingly, at least one embodiment of the present invention provides a method to condense and/or filter data using hashing.

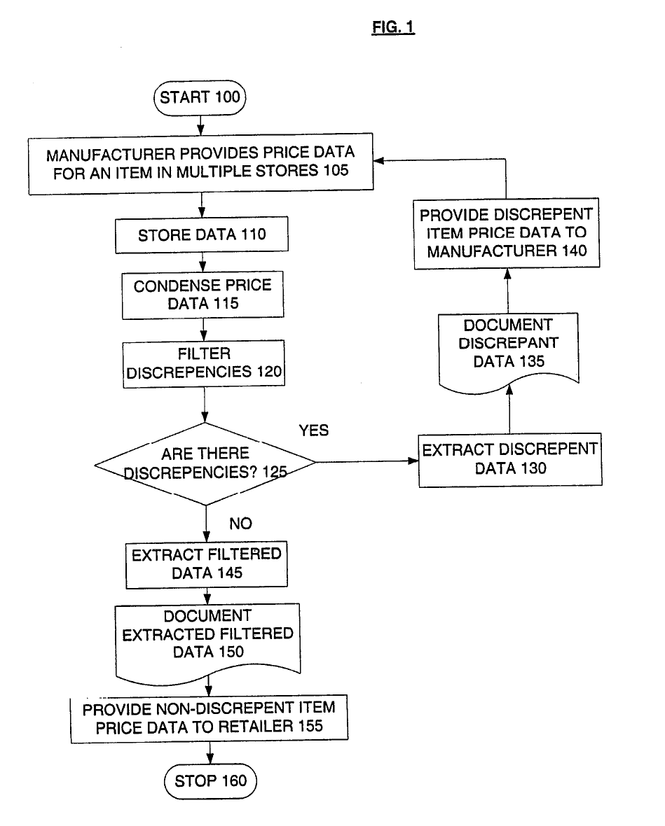

FIG. 1 illustrates operations performed for the data compression and quality checking process according to at least one embodiment of the invention. The process begins at 100, at which pricing data records 500 are assembled by the manufacturer. Control proceeds to 105, at which data records for a specific item are sent by a manufacturer. The data is then stored in a computer system at 110.

That computer system may be hosted and/or operated by the manufacturer, the retailer or a third party exchange whereby multiple manufacturers can interact with multiple retailers 920. The data records contain pricing information (condensable information), including a start date, end date, price type (e.g., wholesale, adjustment, . . . ) and value (e.g., $1.00), plus store related information (i.e., non-condensable information) for the store where the item is sold, including a store identifier. Multiple data records may be sent for each item, with each record indicating a specific price adjustment for a specific time span in a specific store, since the pricing information can vary across time and can be sold in many stores.

Following data storage, control proceeds to 115 at which data condensing is performed. This is accomplished by combining records with the same start date, end date, adjustment type and price of the data for a specific item. Following the condensing operation, control proceeds to 120, at which a filtering operation is performed such that the condensed data is filtered to find any discrepancies. Discrepancies may include pricing records that are not the same in all stores for a given item for a given time span. Control then proceeds to 125, the condensed and filtered data is then checked for any discrepancies and a determination is made whether discrepancies exist.

If discrepancies exist (i.e., answer is YES at 125), control proceeds to 130, at which the discrepant data is extracted and control proceeds to 135. At 135, the discrepant data is documented and control proceeds to 140. At 140, the documented discrepant data is returned to the manufacturer for correction. Subsequently, control returns to 105, at which the manufacturer retransmits the corrected data back into the system. Subsequently, the corrected data may be stored and the condensing operation 115 and filtering operation 120 may then be repeated.

If, at 125, a determination is made that no discrepancies exist (i.e., answer is NO at 125), control proceeds to 145, at which the filtered data is then extracted. Control then proceeds to 150, at which the extracted filtered data is then documented. The documented filtered data is then sent to the retailer at 155. Control then proceeds to 160 at which the data compression and quality checking operation ends.

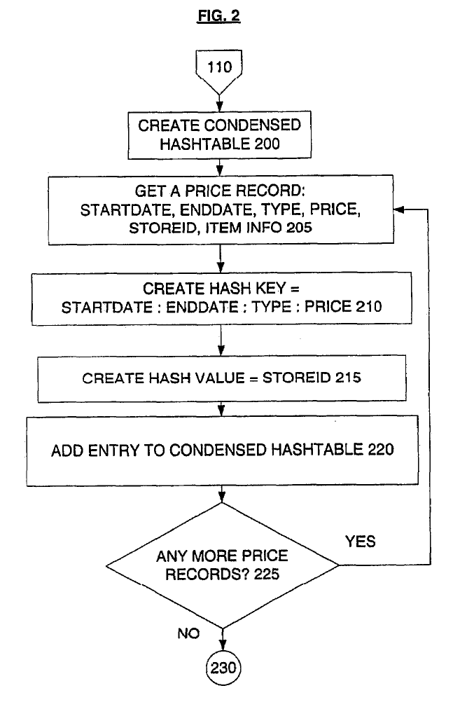

In connection with FIG. 2, the condensing operation performed at 115 for condensing the data will be described in greater detail. The operation begins at 200, at which the creation of a hashtable, which may be, for example, a Condensed Hashtable, is commenced. The Condensed Hashtable may be created from the data, which was stored at 110. This hashtable may use open-ended hashing which preserves the values when key collisions occur.

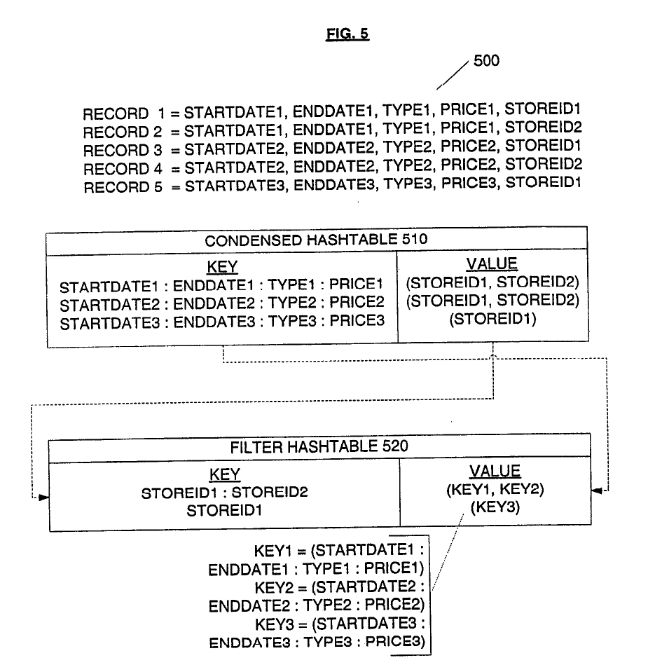

Operations proceed to 205, at which the price records 500 for a given item are retrieved. One exemplary format for the price records 500 is shown in FIG. 5. The data records 500 represent information associated with a plurality of stores, the information being in a X-to-Y relationship, where X (i.e., the pricing information) is distributed identically across Y (i.e., the store information).

Control proceeds to 210, at which, for each price record to be entered into the Condensed Hashtable, a hash key is created. The hash key may be created, for example, by concatenating the string representation of the start date, stop date, price type and value; each of which is separated by a colon (:) character to prevent namespace collision. It is contemplated that the separator character can be any character that does not naturally occur in the data used to create the hash key. However, the same separator character must be used for all hash keys.

Control proceeds to 215, at which a hash value is created. The hash value for the hashtable record may be an object that contains the store ID for the price record. Control then proceeds to 220, at which information (a new entry for the presently processed record) is added to the condensed hashtable.

The format of the condensed hashtable 510 may be, for example, as illustrated in FIG. 5. The table 510 may include keys and corresponding values.

Control proceeds to 225, at which a determination is made as to whether or not additional price records exist. If additional price records exist (i.e., the answer at 225 is YES), control returns to 205 at which additional price records can be retrieved. The process is then repeated until all price records have been retrieved. If there are no additional price records (i.e., the answer at 225 is NO), the operation proceeds to 230 whereby the condensing operation is complete. The condensed price data may then, optionally, filtered to detect any discrepancies.

The hashing function may then be used to condense the data since identical pricing information will result in the creation of identical keys, which the hashtable will map to a single key. This may be more efficient than sorting the pricing information and doing comparisons to find duplicate keys. This gives a mapping from a common price adjustment to a set of stores.

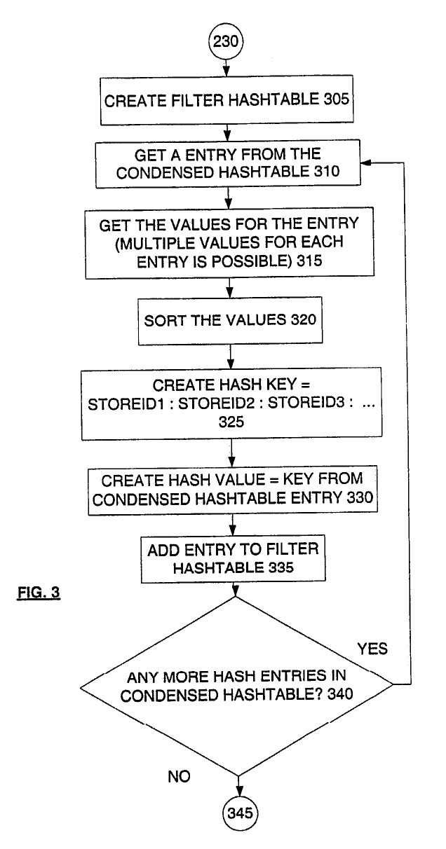

The process 120 of filtering the condensed data is illustrated in greater detail in FIG. 3. As shown in that figure, the operations begin at 305, at which the creation of a hashtable, which may be, for example, a Filter Hashtable 520, is commenced. This hashtable may also use open-ended hashing which preserves the values when key collisions occur. Control then proceeds to 310, at which an entry from the Condensed Hashtable 510 is retrieved so that an entry may be created to be inserted into the Filterable Hashtable 520. Each entry in the Filterable Hashtable 520 may include a hash key and a hash value.

Control then proceeds to 315, at which the values (i.e., store ID's) from the Condensed Hashtable 510 are retrieved to create a key in the Hashtable 520. It is possible that multiple values may exist for each entry. Control then proceeds to 320, at which the values from the Hashtable 510 are sorted such that hash keys can be created at 325. Thus, at 325, the key is created by concatenating the string representation of the store ID's. Each store ID is separated by a colon (:) character to prevent namespace collision. This separator character can be any character that does not naturally occur in the data used to create the key. The same separator character must be used for all keys. As shown in FIG. 5, the keys in Hashtable 520 are created from the values in the Hashtable 510.

Control then proceeds to 330, at which the hash values are created from the keys in the Condensed Hashtable 510. The value for the Filter Hashtable record may be the key from the corresponding Condensed Hashtable entry. The value for the Filter Hashtable 520 may be a representation of the price data for the set of stores used to create the key. This gives a mapping from a set of stores to a common price record.

Control then proceeds to 335, at which the created key and value entry is then added to the Filter Hashtable 520. Control proceeds to 340, at which a determination is made as to whether or not there are any additional hash entries from the Condensed Hashtable 510. If additional entries exist (i.e., the answer at 340 is YES), the filtering process returns to 310 such that another entry can be retrieved from the Condensed Hashtable 510 and operations at 310-340 are repeated until no additional entries exist (i.e., the answer at 340 is NO). When the answer is NO, the Filter Hashtable 520 is complete and control proceeds to 345, at which the determination is made at 125 (illustrated in FIG. 1) as to whether or not any discrepancies exist.

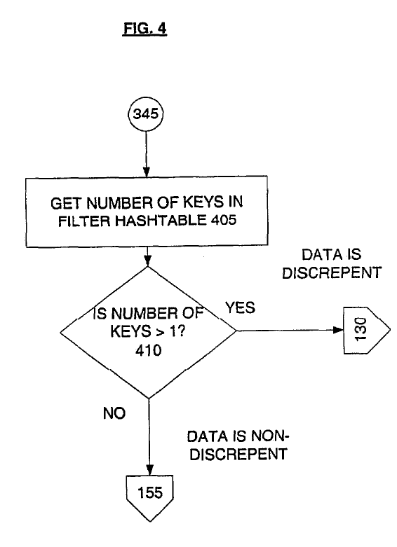

The operations performed at 125 for determining if any discrepancies exist in the pricing information across a set of stores is described in greater detail in connection with FIG. 4. Operations begin at 405, at which a count is taken to determine the number of keys in the Filter Hashtable. Control then proceeds to 410, at which a determination is made to as to whether the count performed at 405 is greater than one. If the count is equal to one (i.e., the answer at 410 is NO), then it is determined that no discrepancies exist in the data and control proceeds to 145 (illustrated in FIG. 1).

The data can then be extracted at 145 so that it may be forwarded to the retailer. In order for the data to be non-discrepant, for a given manufacturer item, the price adjustment records for that item must be the same in all the stores in the set. If this condition is true, then the Filter Hashtable will have one entry whose key is the set of stores and whose values is the set of price adjustment records. More than one entry indicates that there was at least one price adjustment record that was not in all the stores in the set of stores for that item.

As such, if the count is greater than one (i.e., the answer at 410 is YES), then it is determined that discrepancies in the data exist. The discrepant data is then extracted at 130 (illustrated in FIG. 1) so that it may be returned to the manufacturer for correction.

The Filtered Hashtable 520 illustrated in FIG. 5 depicts the existence of discrepancies because more than one key entry is present. When there are no discrepancies, a single key is present in the Filtered Hashtable 520.

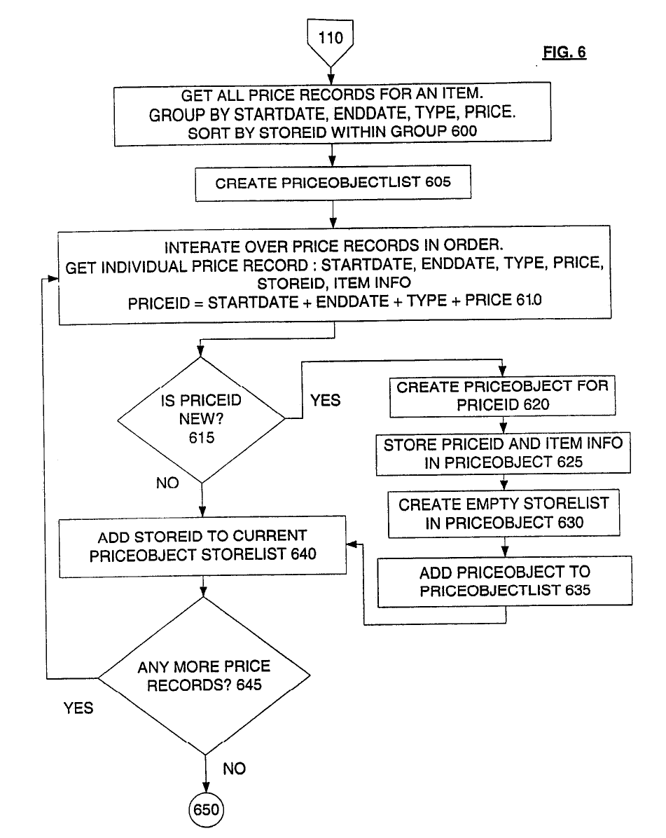

A variation of the condensing operation 120 will be discussed in connection with FIG. 6. The data stored at 110 (illustrated in FIG. 1) may be used in the condensing operation. At 600, all of the price records for an item are retrieved and grouped according to the start date, stop date, price type, and value. Within each group, the records are sorted by ascending store ID. Control then proceeds to 605, at which the process of creating a priceObjectList 800 of priceObjects 805 for every distinct combination of (start date, stop date, price type, value) in the records is initiated. Control continues to 610, at which a priceID is created from each price record. Each price record may include, for example, the following information: startdate, enddate, type, price, storeID and item information. The priceID may be created from the start date, the enddate, type and price. Control proceeds to 615, at which a determination is made as to whether or not the created priceID is new. If the priceID is new (i.e., the answer is YES at 615), control proceeds to 620, at which a new priceObject 805 is created. Control then proceeds to 625, at which the corresponding priceID and the item information is stored in the new priceObject. Control continues to 630, at which an empty storeList 810 is created.

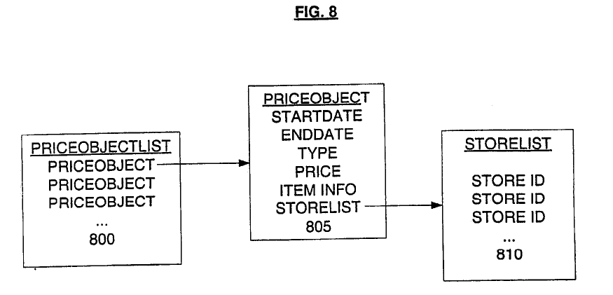

As shown in FIG. 8, the storeList 810 may include, for example, individual store ID's.

Returning to FIG. 6, control proceeds to 635, at which the new priceObject containing the empty storeList 810 is added to the priceObjectList 800. Control then flows to 640, at which the store Id for each record corresponding to the priceObject is added to the priceObjectList 800.

Control then proceeds to 645, at which a determination is made as to whether or not any additional price records exist. If the answer to this determination is YES, then control returns to 610 at which a priceID is created for the additional record and control then flows through operations performed at 615. If the priceID is new (i.e., the answer is YES at 615), then operations 620-640 are repeated. If the priceID is not new (i.e., the answer is NO at 615), then operations only at 640 are repeated.

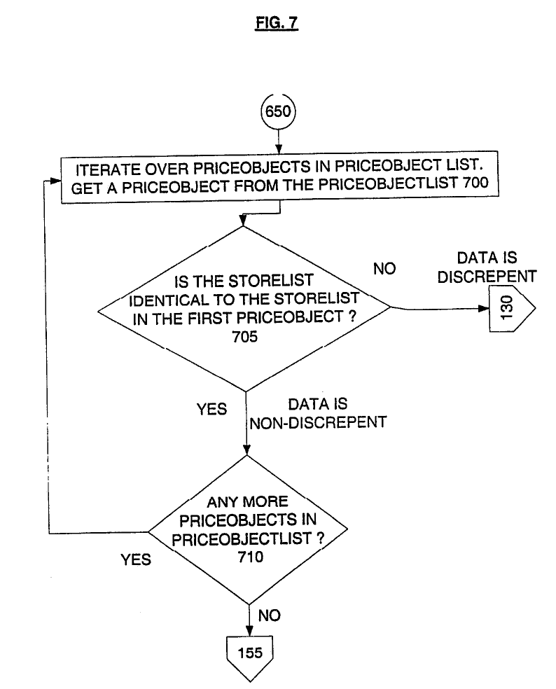

Subsequently, if the answer to the determination at 645 is NO, then the priceObjectList 800 is complete such that it contains all unique priceObjects 805. Control proceeds to 650, at which operations illustrated, for example, in FIG. 7, in which a filtering operation of the priceObjectList 800 is commenced.

Thus, a variation of the filtering operation 120 for filtering the store lists and detecting discrepancies, which may be used in tandem with the condensing operation illustrated in FIG. 6 will be discussed in greater detail in connection with FIG. 7. The filtering and detecting operation is commenced at 700, whereby the list of store ID's for each priceObject 805 in the priceObjectList 800 is compared to the list of store ID's in the first priceObject. Control then proceeds to 705, at which a determination is made as to whether or not the list of store ID's is identical. If the answer to the determination at 705 is NO, then the data is deemed discrepant. As such, control proceeds to 130 (illustrated in FIG. 1), such that the discrepant data can be extracted and returned to the manufacturer for correction. If the answer to the determination at 705 is YES, then the data is deemed not to be discrepant. As such, control proceeds to 710, at which it is determined whether or not any additional priceObjects 805 are in the priceObjectList 800. If the answer to the inquiry in at 710 is YES, then control returns to 700 and operations at 700 and 705 are repeated. If the answer to the determination at 710 is NO, then all data has been filtered and checked for discrepancies. No discrepancies are deemed to exist; therefore, control proceeds to 145 (illustrated in FIG. 1) at which the filtered and checked data is extracted.

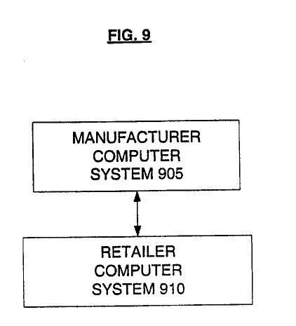

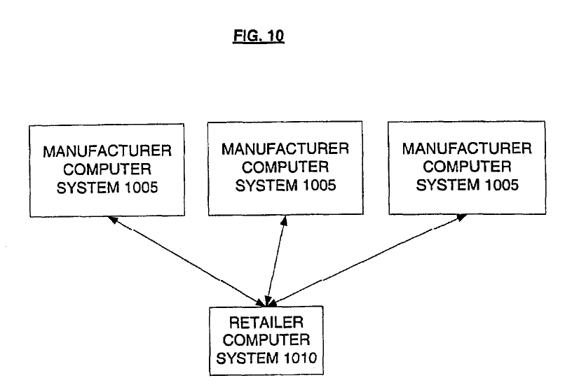

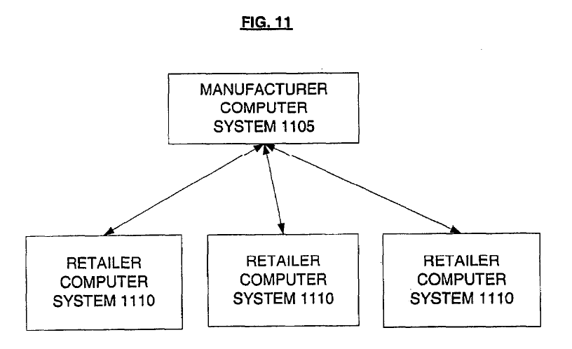

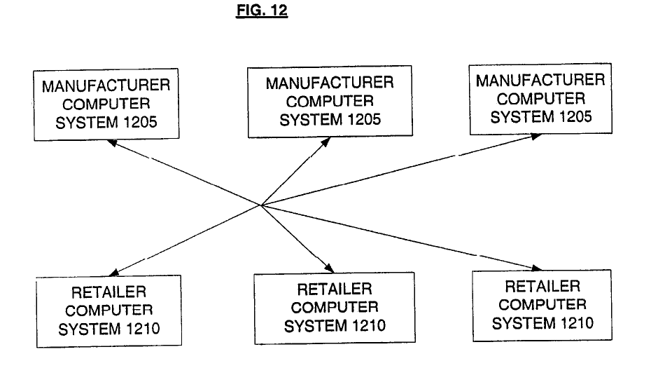

FIGS. 9-12 illustrate the various combinations of manufacturer and retailer relationships that may be supported. FIG. 9 illustrates the relationship between one manufacturer 905 and one retailer 910. FIG. 10 illustrates the relationship between many manufacturers 1005 and one retailer 1010. FIG. 11 illustrates the relationship between one manufacturer 1105 and many retailers 1110. FIG. 12 illustrates the relationship between many manufacturers 1205 to many retailers 1210.

Although the invention has been described above with reference to the examples illustrated in the attached drawings, it is obvious that the invention is not restricted thereto but it can be modified in many ways within the scope of the inventive idea presented in the attached claims. For example, it is contemplated that the condensing operations described above may be performed alone or in combination with the filtering operations described above. Furthermore, it is contemplated that the filtering operations described herein may be performed alone or in combination with the condensing operations performed herein. While the invention has been described in connection with pricing information associated with the manufacturer/retailer supply chain, the present invention is not intended to be so limited. It is contemplated that the present invention has broad application in the supply/manufacturer supply chain (e.g., when a supplier supplies multiple parts or multiple components to multiple manufacturers). The present invention also has broad application where it is necessary to transfer large amounts of data and it is necessary to promptly and efficiently quality check the data for discrepancies.

What is claimed is:

1. A method of compressing and filtering data transmitted from a source to a receiving process in a data processing system, the method comprising:
condensing data;
filtering the data to detect discrepancies;
detecting discrepancies in the data;
creating a document identifying discrepant data; and
creating a document identifying non-discrepant data.

2. The method according to claim 1, wherein condensing the data further comprising:
establishing a condensed hashtable to condense the data,
wherein the key of said condensed hashtable represents the part of data that can be condensed and the value of said condensed hashtable represents the part of the data that cannot be condensed.

3. The method according to claim 2, wherein the filtering the data to detect discrepancies further comprising:
establishing a filter hashtable to filter and detect discrepancies in the data,
wherein a key of said filter hashtable representing the value part of the data from said condensed hashtable and a value of said filter hashtable representing the key part of the data from said condensed hashtable.

4. The method according to claim 3, wherein detecting discrepancies includes determining the number of keys in the filter hashtable.

5. The method according to claim 1, wherein condensing the data includes condensing the data via grouping and sorting the data and storing it as a set of related objects.

6. The method according to claim 5, wherein the filtering and detecting discrepancies the data includes iterating over the data and comparing the lists of a predetermined characteristic.

7. The method according to claim 1, further comprising forwarding the document identifying discrepant data to the source for correction.

8. The method according to claim 1, further comprising forwarding the document identifying non-discrepant data to a third party.

9. A method of handling item pricing information transmitted from a manufacturer to a receiving process in a data processing system, the method comprising:
condensing data related to pricing information;
filtering the data to detect discrepancies;
detecting discrepancies in the data;
creating a document identifying discrepant data; and
creating a document identifying non-discrepant data.

10. The method according to claim 9, wherein condensing the data further comprising:
establishing a condensed hashtable to condense the data,
wherein the key of said condensed hashtable represents the part of data that can be condensed and the value of said condensed hashtable represents the part of the data that cannot be condensed, where the data represents information associated with a plurality of stores, the information being in a X-to-Y relationship, where X (condensable) is distributed identically across Y (non-condensable).

11. The method according to claim 10, wherein the filtering the data to detect discrepancies further comprising:
establishing a filter hashtable to filter and detect discrepancies in the data,
wherein a key of said filter hashtable representing the value part of the data from said condensed hashtable and a value of said filter hashtable representing the key part of the data from said condensed hashtable.

12. The method according to claim 11, wherein detecting discrepancies includes determining the number of keys in the filter hashtable.

13. The method according to claim 9, wherein condensing the data includes condensing the data via grouping and sorting the data and storing it as a set of related objects.

14. The method according to claim 13, wherein the filtering and detecting discrepancies the data includes iterating over the data and comparing the lists of a predetermined characteristic.

15. The method according to claim 14, wherein the predetermined characteristic is a store ID.

16. The method according to claim 9, further comprising forwarding the document identifying discrepant data to the manufacturer for correction.

17. The method according to claim 9, further comprising forwarding the document identifying non-discrepant data to a third party.

18. The method of claim 2, wherein the key of said condensed data hashtable is created by concatenating the string representation of the condensable parts of the data.

19. The method of claim 18, wherein the components of the key string are separated by a separator character not naturally occurring in the components.

20. The method of claim 3, wherein the key of said filter hashtable is created by concatenating the string representation of the value(s) associated with a key in said condensed price data hashtable, in sorted order.

21. The method of claim 20, wherein the components of the key string are separated by a separator character not naturally occurring in the components.

22. A method of compressing data transmitted from a source to a receiving process in a data processing system, the method comprising:
condensing the data by establishing a condensed hashtable to condense the data,
wherein the key of said condensed hashtable represents the part of data that can be condensed and the value of said condensed hashtable represents the part of the data that cannot be condensed.

23. The method according to claim 22, wherein condensing the data includes condensing the data via grouping and sorting the data and storing the data as a set of related objects.
